(19) United States
(12) Patent Application Publication
(10) Pub. No.: US 2013/0194666 A1
(43) Pub. Date: Aug. 1, 2013

(54) PROBABILITY-BASED DETERMINATION OF A MODE OF ACTUATION FOR AN IMAGE STABILIZATION DEVICE

(71) Applicant: Carl Zeiss Sports Optics GmbH, Wetzlar (DE)

(72) Inventors: Steffen Teroerde, Marburg (DE); Michailas Romanovas, Villingen-Schwenningen (DE); Lasse Klingbeil, Siegburg (DE)

(73) Assignee: Carl Zeiss Sports Optics GmbH, Wetzlar (DE)

(21) Appl. No.: 13/739,216

(22) Filed: Jan. 11, 2013

Related U.S. Application Data
(60) Provisional application No. 61/586,336, filed on Jan. 13, 2012.

(30) Foreign Application Priority Data
Jan. 13, 2012 (DE) 102012000861.9

(51) Int. Cl. G02B 27/64

(52) U.S. Cl. CPC G02B 27/646
USPC 359/554

(57) ABSTRACT

The present invention relates to a long-range optical device having at least one tube which contains an optical system, having at least one image stabilization device which is designed to move at least one optical assembly of the optical system relative to the at least one tube, having at least one signal processing unit which is designed such that it actuates the at least one image stabilization device in one mode from a plurality of modes, wherein each mode has an associated respective movement situation for the long-range optical device, and having a mode detection unit which is designed such that it determines the mode from the plurality of modes. Furthermore, the mode detection unit is designed such that it determines the mode by ascertaining a probability of presence of a first movement situation which has an associated first mode, and takes a comparison of the ascertained probability with a random number as a basis for making a decision about actuation in the first mode. In addition, the present invention relates to an appropriate method for determining a mode for actuation of an image stabilization device.

### CROSS-REFERENCE TO RELATED APPLICATIONS

This application claims the priority of German patent application No. DE 10 2012 000 861.9, filed Jan. 13, 2012, and of U.S. provisional application No. 61/586,336, filed Jan. 13, 2012.

### BACKGROUND OF THE INVENTION

The present invention relates to a long-range optical device having at least one tube in which contains an optical system is positioned, having at least one image stabilization device which is designed to move at least one optical assembly of the optical system relative to the at least one tube, having at least one signal processing unit which is designed such that it actuates at least one image stabilization device in one mode from a plurality of modes, wherein each mode has an associated respective movement situation for the long-range optical device, and having a mode detection unit which is designed such that it determines the mode from the plurality of modes.

Furthermore, the present invention relates to a method for determining a mode for actuation of an image stabilization device in a long-range optical device, wherein the image stabilization device is actuated in one mode from a plurality of modes, wherein each mode has an associated respective movement situation for the long-range optical device.

The long-range optical devices within the meaning of the present invention may be monocular or binocular telescopes, for example. Therefore, when the text below refers to a monocular or binocular telescope, this is in no way intended to be understood as a restriction for the type of long-range optical device. In principle, long-range optical devices may be other than modular or binocular telescopes, for example a camera.

Long-range optical devices frequently have image stabilization in order to compensate for quivering rotary movements by the long-range optical device. In this case, the quivering movements may stem from a user of the long-range optical device who is holding the long-range optical device in front of his eyes, but then may also be caused by a particular foundation, for example when the user is on a ship. The quivering movements in this case usually occur primarily about a vertical axis and a lateral axis of the long-range optical device. These quivering rotary movements cause a visible image resolution to suffer and small image details are made unidentifiable. In addition, the blurred image is frequently perceived as a nuisance by a user.

The prior art has therefore made various proposals for types of image stabilization. By way of example, purely mechanical image stabilization systems are known. These may have a purely passive action, for example in the manner of an eddy current brake. However, active systems are also known which use actuators to affect an image stabilization device.

In particular, it is possible for the actuators of an active mechanical image stabilization system to be embedded into a control loop, with the actuators being actuated by a central signal processing unit of the long-range optical device. The type of optical elements which are affected by means of the image stabilization device in order to bring about the image stabilization may also be different. The prior art has proposed various solution options for this, for example rotation of the inversion system, which may be a lens inversion system or a prism inversion system, about one or more axes relative to a tube or housing element of the long-range optical device, or movement of the objective lens or a portion of the objective lens perpendicular to an optical axis of the long-range optical device. Purely software-based implementations of image stabilization are also possible, particularly in combination with digital picture shooting. Apart from in the case of purely passively operating mechanical systems, it is conceivable, in principle, for the present invention to be used together with all other types of image stabilization.

For image stabilization, it is desirable to compensate for the movements by the long-range optical device on account of external influences only when the movements are unintentional. These unintentional movements are referred to as quivering movements or quivering rotary movements within the context of this application. These need to be distinguished from intentional movements, however, for example when a user swivels the long-range optical device in order to view another object, or when the user follows a moving object during a view. Naturally, there is no need to compensate for the movement in the case of these intentional movements. Otherwise, the long-range optical device would initially irritate the user by behaving such that the image remains stationary even though the user is swivelling the long-range optical device. Furthermore, an image stabilization device would achieve maximum possible compensation or deflection from a certain scope of movement onwards and would come to rest at that point.

Therefore, in the long-range optical devices usually a device which is subsequently called a mode detection unit is provided, which may be implemented in hardware or in software. The mode detection unit may be provided separately, but also as part of the central signal processing unit, for example, and is used to distinguish between unintentional quivering rotary movements and intentional swivel or tilt movements. A distinction is therefore drawn between different movement situations, which each have a respective associated corresponding mode of image stabilization which takes account of the nature of the movement situation, i.e. whether it is unintentional or intentional. Various proposals have already been made for the distinction between different movement situations and the accompanying stipulation of a mode of image stabilization.

Thus, by way of example, the document DE 199 37 775 A1 shows a level detector which senses a present angular speed signal and uses a threshold value comparison to influence the type of actuation of an image stabilization device, for example by bypassing a high-pass filter and an integrator unit for the angular speed signal. Different modes of image stabilization are therefore distinguished using a fixed threshold value.

The document U.S. Pat. No. 6,384,976 B1 likewise shows the determination of the mode of image stabilization using a comparison of an angular speed signal with a fixed threshold value. When a threshold value is exceeded, the system switches to another mode. When there is a drop below the same threshold value or another threshold value again, the system switches back to the original mode.

The document U.S. Pat. No. 7,460,154 B2 likewise shows determination of the mode of image stabilization using a comparison of an angular speed and/or an angle with a fixed threshold value.

The document EP 1 980 904 A2 also shows a distinction between different modes of image stabilization using a comparison with a particular threshold value.

Finally, the document EP 1 708 019 A1 also proposes performing a comparison with a fixed threshold value, in this case using a correction value, calculated by a central data processing unit, for actuating the image stabilization device.

Finally, an isolated other solution option in the document U.S. Pat. No. 5,930,530 A is concerned with predicting vibrations by virtue of identification of regularities and appropriate actuation on the basis of a prediction that is derived therefrom. In this case, there is no distinction between particular modes, however.

In order to distinguish between a plurality of modes or in order to determine a particular mode for the image stabilization, the prior art thus proposes performing a comparison with a fixed threshold value. However, the value stipulated for the threshold value influences the behaviour of the long-range optical device unalterably. If such a threshold value is set to be too low or too high, an intentional movement of the long-range optical device is identified even though it is not at all intentional, for example. Furthermore, it may happen that a very slow intentional swivel or tilt movement is not identified as an intentional movement and is therefore compensated for by the image stabilization. In addition, the individual use behaviour of a user may govern what stabilization behaviour or what threshold values said user finds agreeable or appropriate in the first place.

### BRIEF SUMMARY OF THE INVENTION

It is therefore an object of the present invention to specify a long-range optical device and a method which provide improved determination of a mode of the image stabilization.

According to a first aspect of the invention, it is provided a long-range optical device having at least one tube in which an optical system is positioned, having at least one image stabilization device which is designed to move at least one optical assembly of the optical system relative to the at least one tube, having at least one signal processing unit which is designed such that it actuates the at least one image stabilization device in one mode from a plurality of modes, wherein each mode has an associated respective movement situation for the long-range optical device, and having a mode detection unit which is designed such that it determines the mode from the plurality of modes, wherein the mode detection unit is furthermore designed such that it determines the mode by ascertaining a probability of presence of a first movement situation which has an associated first mode, and takes a comparison of the ascertained probability with a random number as a basis for making a decision about actuation in the first mode.

According to a second aspect of the invention, it is provided a method for determining a mode for actuation of an image stabilization device in a long-range optical device, wherein the image stabilization device is actuated in one mode from a plurality of modes, wherein each mode has an associated respective movement situation for the long-range optical device, wherein the mode from the plurality of modes is ascertained by determining a probability of presence of a first movement situation which has an associated first mode and using a comparison of the ascertained probability with a random number to make a decision about actuation in the first mode.

According to a third aspect of the invention, it is provided a computer program having program code means which is designed to execute all the steps of a method for determining a mode for actuation of an image stabilization device in a long-range optical device, wherein the image stabilization device is actuated in one mode from a plurality of modes, wherein each mode has an associated respective movement situation for the long-range optical device, wherein the mode from the plurality of modes is ascertained by determining a probability of presence of a first movement situation which has an associated first mode and using a comparison of the ascertained probability with a random number to make a decision about actuation in the first mode, when the computer program is executed on a computer.

According to a fourth aspect of the invention, it is provided a computer program product having program code means which are stored on a computer-readable data storage medium in order to perform a method for determining a mode for actuation of an image stabilization device in a long-range optical device, wherein the image stabilization device is actuated in one mode from a plurality of modes, wherein each mode has an associated respective movement situation for the long-range optical device, wherein the mode from the plurality of modes is ascertained by determining a probability of presence of a first movement situation which has an associated first mode and using a comparison of the ascertained probability with a random number to make a decision about actuation in the first mode, when the computer program is executed on a computer or an appropriate data processing unit.

Instead of a fixed threshold value, the invention therefore ultimately proposes a random-number-dependent function for determining a mode of image stabilization, particularly for distinguishing between movements that do not need to be stabilized, i.e. intentional swivel and rotary movements, and movements that need to be stabilized, i.e. unintentional quivering movements. The distinction is therefore no longer rigid on the basis of the fixed threshold values, but rather a softer random-number-dependent transition takes place between the different modes, which a user of the long-range optical device usually finds agreeable.

The first movement situation may be the “intentional swivelling or rotation” movement situation, for example, but may also be the “unintentional quivering” movement situation, for example. The probability of this first movement situation being present is dynamically dependent on a movement behaviour from the long-range optical device in this case. The term “random number” is intended to be understood to mean both a pseudorandom number and a genuine random number. The decision about the actuation is made by comparing the probability with the random number. In particular, a numerical range for the probability and a numerical range for the random number are the same.

By way of example, the probability can be expressed in the form of a number between 0 and 1. Accordingly, the random number may also be in a range between 0 and 1. The random number generated should naturally be distributed evenly over the range. The decision can then be made using a test to determine whether the random number is less than or equal to the probability. Depending on whether this statement is true or false, it is thus possible to make a decision. In particular, the plurality of modes may be precisely two modes, particularly for a first mode being associated with an “intentional movement” movement situation and a second mode being associated with an “unintentional movement” movement situation.

This affords the advantage that the mode is determined not by means of a rigid decision but rather by means of a dynamic decision. In addition, the time of the decision cannot be predicted by a user from a change of the mode. In addition, a variation in the determination of the probability of the first movement situation provides opportunities for customizing the stabilization behaviour in a user-specific fashion. The image stabilization is also prevented from misbehaving on the basis of incorrectly stipulated threshold values. The disadvantages known from the prior art can thus be eliminated.

In one refinement of the invention based on the first aspect, provision may be made for the mode detection unit to be designed such that it makes a decision about actuation in the first mode by making a decision about changing to the first mode when the at least one signal processing unit actuates the at least one image stabilization device in another, second mode, and makes a decision about remaining in the first mode when the at least one signal processing unit is already actuating the at least one image stabilization device in the first mode.

Accordingly, one refinement of the method according to the invention based on the second aspect may also have provision for the decision about the actuation in the first mode to be made by making a decision about changing to the first mode when the at least one image stabilization device is being actuated in another, second mode, and a decision about remaining in the first mode is made when the at least one image stabilization device is already being actuated in the first mode.

Usually, the image stabilization is first of all prescribed a mode as a starting condition. If a decision is now made to the effect that there is a movement situation present which has the associated first mode, the system changes to the first mode if the present mode is another mode, and remains in the first mode if the present mode is actually also the first mode. Hence, the decision to change the mode or to remain in a mode is based on a random number or a probability. In particular, both the refinement of the long-range optical device and the refinement of the method may have provision for precisely two modes to form the plurality of modes. In this case, one mode corresponds to the “intentional movements” movement situation and the other mode corresponds to the “unintentional movements” movement situation. The first mode may then be associated with the “intentional movements” movement situation, for example.

In a further refinement of the long-range optical device based on the first aspect, provision may be made for the mode detection unit to be designed such that it ascertains the probability using the formula

$$p ( σ , T , k ) = \frac{1}{1 + {e}^{- k ( σ - T )}} ,$$

where p is the probability, k and T are each a parameter greater than zero and σ is the value of an input signal integrated over a particular period of time.

Accordingly, one refinement of the method based on the second aspect of the invention may also have provision for the probability to be ascertained using the formula

$$p ( σ , T , k ) = \frac{1}{1 + {e}^{- k ( σ - T )}} ,$$

where p is the probability, k and T are each a parameter greater than zero and σ is the value of an input signal integrated over a particular period of time.

In this case, the input signal stems from a sensor element which senses a movement or a speed or an acceleration of the long-range optical device. This may be either a translational movement or translational speed or translational acceleration or an angle or angular speed or angular acceleration. In particular, provision may be made for the input signal to be the measurement signal from a rotation rate sensor, for example of type ST LPY503AL from the STMicroelectronics company, which can sense an angular speed of the long-range optical device about one or more axes with reference to an inertial system at rest.

The sensor element is used to pick up measurement signals at a fixed frequency, for example 100 Hz. These are then integrated, i.e. integrated over the particular period of time, using a respective fixed or determined number of the signals picked up most recently, in order to evaluate the present movement situation. If, for example at a measurement signal frequency of 100 Hz, the last 20 signals are used for integration, a movement situation for the last 200 ms is assessed. This integrated movement σ is used to determine the probability of a particular movement situation being present.

The specified function p(σ,T,k) ultimately delivers a numerical value 0≦p≦1 which indicates the probability of the first movement situation being present. It goes without saying that in this case the number of decimal places handled and any rounding govern whether the value “0” can actually be achieved. In particular, the function p(σ,T,k) is therefore used to define how great the probability is of whether the “intentional movement” movement situation is present. The larger the integrated input signal, the higher therefore is the probability of this movement situation and hence also of changing to or remaining in the mode associated with the movement situation.

The parameters T and k can, in principle, be chosen freely. In this case, the parameter T is the “threshold” of the function, i.e. that value for σ at which the probability is 50% or 0.5. If the input signal σ is scaled to a range between 0 and 1 using a stipulated maximum value, the parameter T may, in principle, likewise be in the range between 0 and 1. In particular, the parameter T may then be in a range from 0.25 to 0.6, particularly may be 0.25, 0.3, 0.4, 0.5 or 0.6. The parameter k is the gradient at this point. Hence, the parameter can, in principle, assume any positive value. If the input signal σ is scaled to a range between 0 and 1 using a stipulated maximum value, the parameter k may be particularly in a range from 5 to 25, particularly may be 5, 8, 10, 12, 15, 18, 20. In particular, the parameters may be chosen on the basis of a present mode of the image stabilization. Hence, the trend or profile chosen for the probability function on the basis of the integrated input signal may be different for changing to the first mode, for example, than for remaining in the first mode. The higher the corresponding probability, the more probable it is that a random number is less than or equal to the probability and hence a decision is made about changing to or remaining in the first mode. In this way, it is possible to make a binary decision about the mode of the image stabilization.

in a further refinement of the long-range optical device based on the first aspect, provision may be made for the mode detection unit to be designed such that it ascertains the probability using the formula

$$p ( σ , T , k ) = \{ \begin{matrix} 0 for σ < T - k \\ \frac{σ - ( T - k )}{2 \cdot k} for T - k \leq σ \leq T + k \\ 1 for σ > T + k ,\end{matrix}$$

where p is the probability, k and T are each a parameter greater than zero or a positive parameter and σ is the value of an input signal integrated over a particular period of time.

Accordingly, one refinement of the method according to the invention based on the second aspect of the invention may have provision for the probability to be ascertained using the formula

$$p ( σ , T , k ) = \{ \begin{matrix} 0 for σ < T - k \\ \frac{σ - ( T - k )}{2 \cdot k} for T - k \leq σ \leq T + k \\ 1 for σ > T + k ,\end{matrix}$$

where p is the probability, k and T are each a parameter greater than zero and σ is the value of an input signal integrated over a particular period of time.

The calculation of an exponential function is relatively complex, particularly when using microcontrollers with merely limited computation power. So as therefore to allow faster calculation of the probability, it is possible to use a linearly approximated function for ascertaining the probability p(σ,T,k). This distinctly reduces the computation complexity for ascertaining the probability.

In a further refinement of the long-range optical device based on the first aspect of the invention, provision may be made for the mode detection unit to be designed such that the probability is dependent on an input signal integrated over a particular period of time, wherein the input signal is a speed or angular speed of the long-range optical device.

Accordingly, one refinement of the method according to the invention based on the second aspect of the invention may also have provision for the probability to be ascertained on the basis of an input signal integrated over a particular period of time, wherein the input signal is a speed or angular speed of the long-range optical device.

A speed or angular speed can be determined relatively well by means of known sensor elements. The integrated input signal then provides a distance or an angle, with a greater distance or a greater angle possibly being a relatively reliable measure of the presence of a particular movement situation, particularly of the presence of an intentional swivel or rotary movement.

In a further refinement of the long-range optical device based on the first aspect of the invention, provision may be made for the mode detection unit to be designed such that the probability is dependent on an input signal integrated over a particular period of time, wherein the input signal is an acceleration or angular acceleration of the long-range optical device.

Accordingly, one refinement of the method according to the invention based on the second aspect of the invention may have provision for the probability to be ascertained on the basis of an input signal integrated over a particular period of time, wherein the input signal is an acceleration or angular acceleration of the long-range optical device.

Accordingly, the integrated input signal is a speed or angular speed in this case. Particularly if a distinction is drawn only between two modes, with the first mode being associated with the “intentional movements” movement situation and the second mode being associated with the “unintentional movements” movement situation, only a very low probability or a probability of zero is then obtained for a uniform intentional swivel or tilt movement, since this has an acceleration of zero. An instance of changing to or remaining in the first mode, which would actually be associated distinctly with the “intentional movements” movement situation, would then not occur, but rather image stabilization as for a quivering rotary movement or as in the “unintentional movements” movement situation would take place. Hence, unintentional quivering rotary movements would be compensated for during the uniform swivel or tilt movement. In this case, the actuation of the image stabilization device should then be in a form such that the uniform swivel or tilt movement is then not compensated for or is ignored.

In a further refinement of the long-range optical device based on the first aspect of the invention, provision may be made for the mode detection unit to be designed such that the random number is formed from a noise in a sensor signal from a sensor element of the long-range optical device.

Accordingly, the method based on the second aspect of the invention may also have provision for the random number to be formed from a noise in a sensor signal from a sensor element of the long-range optical device.

In principle, the random number can be calculated by appropriate algorithms, and many microcontrollers provide optimized functions for this purpose. However, calculating such a random number or pseudorandom number is all the more complex the better the quality of the random number is supposed to be. Another possibility, even for generating a genuine random number, therefore involves forming the random number from the noise which occurs in a sensor signal from a sensor element of the long-range optical device, for example from the noise in an angular speed sensor. By way of example, the respective last binary digit in the measurement signal picked up can be considered to be a random number having a value either 0 or 1, with a suitable combination or juxtaposition of these numbers being able to generate a random number. By way of example, the respective last eight measured binary random signals can generate a natural random number in a range from 0 to 255 by virtue of respective shifts. This range could accordingly be transformed to the range of probability from 0 to 1. It is naturally also possible to use more or fewer than the last eight measured binary random signals; if more than eight binary random signals are used, for example, then the range from 0 to 1 is resolved to a higher degree. The advantage of this determination lies in distinctly reduced computation complexity while ascertaining a genuine random number.

In a further refinement of the long-range optical device based on the first aspect, provision may be made for the mode selection unit to be designed such that the parameters k and T are stipulated on the basis of a mode in which the image stabilization device is actuated and/or are stipulated on the basis of an instance of application.

Accordingly, a method based on the second aspect of the invention may also have provision for the parameters k and T to be stipulated on the basis of a mode in which the image stabilization device is actuated and/or to be stipulated on the basis of an instance of application.

Hence, it is not imperative for the parameters T and k to apply globally to all modes. On the contrary, the parameters T and k may each be determined and stored individually for each mode that is present. In the case of the example of just one first mode and one second mode, the effect thus arises that the trend of the probability of a change to the first mode is different from the trend of the probability of remaining in the first mode. It is thus possible to produce particularly softer transitions between the individual modes.

In addition, it is furthermore possible for the parameters T and k to be dependent not only on a respective mode but additionally also on an instance of application. Alternatively, they may also be dependent just on an instance of application. Examples of such instances of application may be “stationary position”, “travel by a water vehicle”, “travel by a land vehicle”, etc.

In one refinement of the long-range optical device based on the first aspect of the invention, provision may be made for the long-range optical device to have an interface device which is designed to set the instance of application.

Accordingly, one refinement of the method based on the second aspect of the invention may also have provision for the long-range optical device to have an interface device which is used to set the instance of application.

This allows the user to set the instance of application, either on the basis of the instance of application which is actually present or on the basis of his personal preferences.

In a further refinement of the long-range optical device based on the first aspect of the invention, provision may be made for the long-range optical device furthermore to have a memory unit which stores at least one reference profile, wherein a respective reference profile has a respective associated instance of application, and the mode detection unit is designed such that it uses a comparison of a profile or trend of the input signal over a particular period of time with the at least one reference profile to stipulate the instance of application.

Accordingly, one refinement of the method based on the second aspect of the invention may also have provision for at least one stored reference profile, wherein a respective reference profile is assigned a respective associated instance of application, to be compared with a trend or profile for the input signal over a particular period of time and for the comparison with the at least one reference profile to be used to stipulate the instance of application.

This allows automatic selection of the instance of application by using the trend or profile of the input signal in a comparison with stored reference profiles to ascertain the instance of application to which the trend or profile of the input signal best corresponds. By way of example, an essentially sinusoidal trend or profile of an input signal could indicate wave movements and hence the “travel by a water vehicle” instance of application, for example. Each instance of application then stores the parameters T and k for each mode. Manual setting of the instance of application using the interface device may be additionally possible and may possibly take priority over automatic ascertainment of the instance of application.

Alternatively, it is additionally also conceivable—both in the case of the long-range optical device based on the first aspect and in the case of the method based on the second aspect—to adaptively customize the free parameters T and k to present ambient conditions globally or separately for each mode by generating the values for the parameters from the input signal which is being picked up at present and the patterns thereof.

In a further refinement of the long-range optical device based on the first aspect of the invention, provision may be made for the mode detection unit to be designed such that it stipulates the incidence of application continuously or at regular intervals of time.

Accordingly, one refinement of the method based on the second aspect of the invention may also have provision for the instance of application to be stipulated continuously or at regular intervals of time.

In the case of digital signal processing, “continuously” in this context is intended to be understood to mean that the instance of application is stipulated in every clock cycle. In this way, the correct instance of application is always kept available. In order to reduce the computation complexity, this can also be effected just at particular intervals of time, for example every ten seconds, every minute, etc.

It goes without saying that the features cited above and those that are yet to be explained below can be used not only in the respectively indicated combination but also in other combinations or on their own without departing from the scope of the present invention.

### BRIEF DESCRIPTION OF THE SEVERAL VIEWS OF THE DRAWING

Exemplary embodiments of the invention are shown in the drawing and are explained in more detail in the description below, in which:

FIG. 1 shows a schematic view of a long-range optical device, the axes thereof and appropriate movement variables,

FIG. 2 shows a schematic side view of an embodiment of a long-range optical device based on the first aspect of the invention and the components of an image stabilization system,

FIG. 3 shows a schematic exemplary flowchart for the signal processing of an image stabilization system for the long-range optical device in FIG. 2,

FIG. 4 shows exemplary trend or profile graphs for a probability of a particular movement situation being present,

FIG. 5 shows a schematic illustration of an exemplary trend or profile of the decisions in a long-range optical device or in a method for determining a mode,

FIG. 6 shows a schematic flowchart for an embodiment of a method based on the second aspect of the invention,

FIG. 7 shows a schematic subflowchart for a further embodiment of the method in FIG. 6,

FIG. 8a shows a graph with an example of an illustration of a trend or profile of a probability for different parameters T and k stipulated on the basis of mode, and

FIG. 8b shows a graph with an example of an illustration of a trend of a probability for different parameters T and k stipulated on the basis of an instance of application.

### DETAILED DESCRIPTION OF THE INVENTION

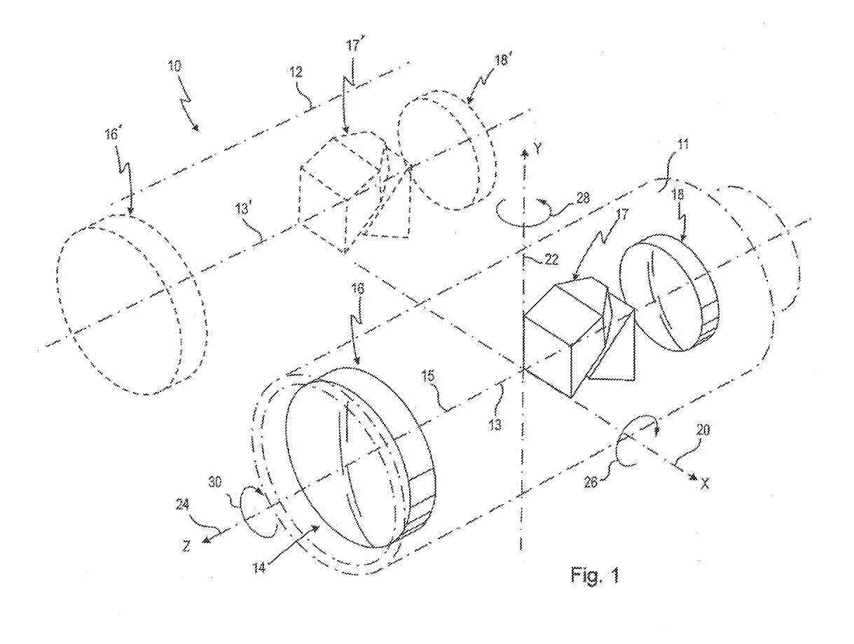

FIG. 1 shows a schematic illustration of a long-range optical device 10 first of all to explain the circumstances in an image-stabilized long-range optical device 10.

The long-range optical device 10 shown has a first tube 11. Furthermore, the long-range optical device may have a second tube 12, for example in the case of a binocular telescope. The circumstances are explained below by way of example with reference to a long-range optical device 10 having just a first tube 11, without this intended to be understood as restrictive, however.

The first tube 11 extends along a longitudinal axis 13. In the first tube 11, an optical system 14 which extends along an optical axis 15 is provided. In the orientation shown, the optical axis 15 and the longitudinal axis 13 coincide. Within the context of image stabilization, the optical axis 15 and the longitudinal axis 13 are moved relative to one another, however, in order to bring about image stabilization. The optical system 14 has an objective lens 16, an inversion system 17 and an eyepiece 18 as optical assemblies. Furthermore, yet further optical elements may be provided. The illustration of the inversion system 17 as a prismatic inversion system is likewise merely intended to be understood by way of example, and another inversion system, for example a lens inversion system, may also be provided.

A lateral axis 20 of the long-range optical device 10 and a vertical axis 22 of the long-range optical device 10 form a Cartesian coordinate system together with the longitudinal axis 13. In this case, the longitudinal axis 13 always forms a third axis 24 of the coordinate system, which third axis is perpendicular to the vertical axis 22 and the lateral axis 20. In principle, an image stabilization system can prompt translational movements in the direction of each of the three coordinate axes 20, 22, 24. Furthermore, rotational movements are possible, namely a pitching movement 26 about the lateral axis 20, a yawing movement 28 about the vertical axis 22 and a rolling movement 30 about the z axis 24. In relation to quivering movements or swivel movements, the pitching movement 26 and the yawing movement 28 are most significant. The image stabilization is described below by way of example with reference to a long-range optical device 10 in which image stabilization is effected using rotary movements of the angle system 17 about the lateral axis 20 and the vertical axis 22, namely in order to compensate for the pitching movement 26 and the yawing movement 28. This is intended to be understood without restricting the invention, however.

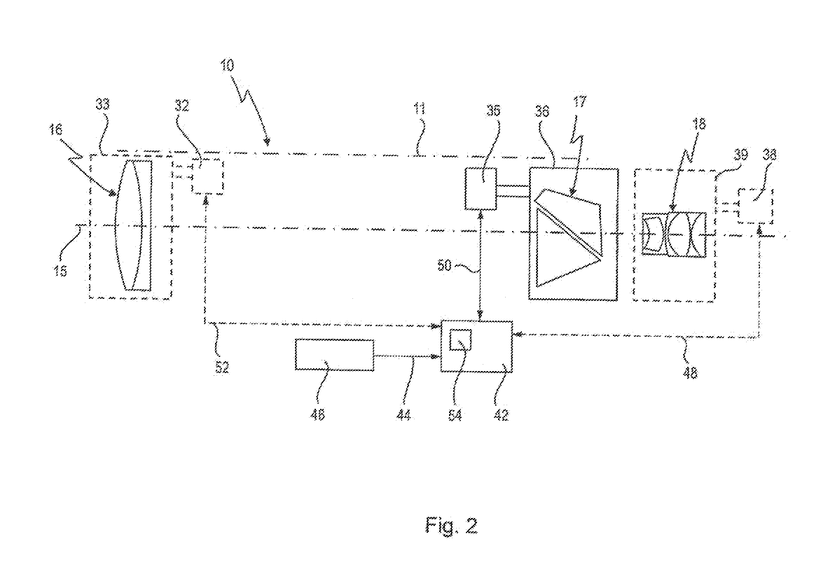

FIG. 2 shows a lateral view of a schematically simplified illustration of the first tube 11 of the long-range optical device 10. The figure shows actuators 32 of an image stabilization device 33 for the objective lens 16, actuators 35 of an image stabilization device 36 for the inversion system 17 and actuators 38 of the image stabilization device 39 for the eyepiece 18. In this case, only the image stabilization device 36 with its actuators 35 are shown in solid lines. In the outlined exemplary embodiment, image stabilization is therefore effected merely by tilting the inversion system 17 about the vertical axis 22 and about the lateral axis 20. In principle, the present invention also allows the objective lens 16 and/or the eyepiece 18 to be moved, however. There are also image stabilization devices known in which, by way of example, both the inversion system 17 and the eyepiece 18 are moved together, i.e. by a single image stabilization device. The exemplary embodiment shown is therefore intended to be understood merely by way of example. It is merely necessary for at least one of the optical assemblies 16, 17, 18 to be able to be moved relative to the tube 11.

Furthermore, the long-range optical device 10 has a signal processing unit 42 which provides the central signal processing in the long-range optical device 10. An input signal 44 is ascertained by at least one sensor element 46 and is input into the signal processing unit 42.

The signal processing unit uses an appropriate line 48, 50, 52 to communicate with a control device of an appropriate actuator 32, 35, 38 for an appropriate image stabilization device 33, 36, 39.

The image stabilization is then effected by virtue of the inversion system 17 being tilted by the actuators 35 of the image stabilization device 36. This shifts the intermediate image within the optical system 14 such that movement of the first tube 11 is compensated for. The actuators 35 are actuated by means of the signal processing unit 42. Accordingly, it then becomes possible to tilt the inversion system 17 through a particular pitch angle 26 relative to the first tube 11, for example, which means in this case a longitudinal axis 13 of the tube 11 and an optical axis 15 separate. In this case, the illustration in FIG. 2 is intended to be understood merely by way of example, as already explained above. It is merely necessary for at least one of the optical assemblies 16, 17, 18 to be able to be moved relative to the first tube 11, and other centres of rotation for the optical axis 15 are then also obtained accordingly. A similar situation arises when compensating for translational movements by means of at least one of the optical assemblies 16, 17, 18.

In order to be able to tilt the inversion system 17 both about the vertical axis 22 and about the lateral axis 20 in the embodiment shown by way of example, it is mounted on two-axis gimbals (not shown), the axes of the gimbals accordingly being at right angles to one another and perpendicular to the longitudinal axis 13. A person of average skill in the art is primarily familiar with two designs for producing the gimbals, it firstly being possible for each axis of the gimbals to be guided in two ball bearings, or else it being possible to use leaf spring elements as solid body joints for suspending the inversion system. In this case, solid body joints have the advantages of greater position precision, since they have less mechanical play, and cheaper production costs.

The actuators 32, 35, 38 are usually linearly moveable actuators. These are arranged at an interval from the longitudinal axis 13 and the optical axis 15 by means of a lever, which means that a linear movement is converted into a rotational movement about the relevant axis. There are primarily three suitable types of actuators, voice coil motors, stepping motors and piezolinear drives.

When using voice coil motors, an electromagnetic coil is mounted either on the inversion system 17, in an intermediate ring of the gimbals or on the first tube 11 or an outer ring of the gimbals. By way of example, the swivel movement is again effected by using scheduled image stabilization about the vertical axis 22 and the lateral axis 20. In the case of accordingly differently scheduled image stabilizations for rotational or translational movements, a person skilled in the art can make the appropriate modifications. A suitable permanent magnet or possibly an electromagnetic coil is mounted as a counterpart on the intermediate ring of the gimbals, the first tube 11 or the outer ring or the inversion system 17, with the result that when a current is applied to the coil a magnetic force acts between the components and rotates the inversion system 17 about the relevant axis of rotation 20, 22. Since the voice coil motors have no holding force, the gimbal joints additionally need to be mechanically locked against tracking down the image stabilization. In this case, if the long-range optical device is binocular, the gimbal joints need to be fixed relative to one another in the first tube 11 and the second tube 12 in a locked state such that parallel beam passage is ensured, with the result that a user of the long-range optical device 10 is not provided with a double image between the image of the optical system 14 from the first tube 11 and the image of the optical system 14′ from the second tube 12, what is known as binocular alignment.

When using voice coil motors, there is no rigid coupling between the coil winding and the permanent magnet used. In this case, it is also possible to choose configurations for the gimbal joint in which the axis movements influence one another. It is thereby possible to place the actuators for both axes, e.g. on a first tube 11 or on the outer ring of the gimbal joint, and the permanent magnet for the first axis on the intermediate ring and the second permanent magnet on the prism system 17 itself. As a result, it is not necessary to use any moving connecting lines for the actuators.

When stepping motors are used, a stepping motor first of all drives a threaded spindle. This threaded spindle drives an entrainer element which executes a linear movement along the spindle. Said entrainer element is connected to the inversion system 17 by means of a lever, with the result that the linear movement is converted into a rotary movement. In addition, a motor is mounted on the first tube 11 or on the outer ring of the gimbals and drives the inner ring of the gimbals via a lever. The second motor is mounted on the inner ring of the gimbals and drives the actual inversion system 17 via a lever. This arrangement means that there is no reciprocal influencing by the two axes. The use of stepping motors for the spindle drive has the advantage that it is possible to provide very large holding forces and large drive forces. As a result, even inversion systems 17 for large long-range optical devices 10 can be moved efficiently, and it is possible to dispense with additional locking of the inversion system 17. Furthermore, stepping motors are very inexpensive as standard components.

When a piezolinear drive is used, an oscillating piezoceramic is used in conjunction with a friction element as a counterpart. The oscillation of the piezoceramic to and fro in different ways moves the friction element situated opposite. In this case, the piezoceramic and the friction element are coupled by means of frictional and contact forces. Since this coupling is not of rigid design, the point of friction can also be shifted perpendicular to the direction of movement, which means that arrangements between two actuators which are not at right angles to one another or which influence one another are also possible. Therefore, both actuators for a first tube 11 can be mounted on the first tube 11 or on the outer ring of the gimbals. The friction element of one actuator is then located on the inner ring and thereby drives one axis, and the friction element of the other actuator is then located on the inversion system 17 and drives the other axis. This setup simplifies the design in so far as none of the actuators themselves are situated on a moving part. This reduces contact connection problems, since no moving lines need to be used. Furthermore, the weight of the inner ring is reduced, which would otherwise additionally have the second actuator seated on it. A piezoactuator has a high level of setting accuracy and at the same time a high speed, which increases the quality of the stabilization. It also has a high level of self-retention, which means that it is possible to dispense with additional locking. In addition, a piezolinear drive is very efficient, which means that the power consumption is low and it is possible to achieve long battery lives for the long-range optical device 10.

The position of the gimbal joint is monitored using a Hall sensor for each axis. In a similar fashion to the actuator system, said Hall sensor is at an interval from the relevant swivel axis, which means that an alteration in the angle of rotation is converted into a linear movement which is measured by the Hall sensor and can be read in by a control device of the actuator system 32, 35, 38.

The at least one sensor element 46 is used to sense the respective angular speeds about the vertical axis 22 and the lateral axis 20. From the relevant measurement signals 47, the signal processing unit 42 calculates a setpoint tilt angle for actuating the actuators 35 of the image stabilization device 36 and transmits said setpoint tilt angle via the line 50. The control device of the actuator 35 uses this setpoint tilt angle as a target value for a control loop which uses an actuator, that is provided for an appropriate rotary movement of the inversion system 17, and an appropriate Hall sensor to move the inversion system 17 to this setpoint tilt angle and to keep it there. This is a control loop which is used to control the speed of an appropriate actuator by comparing the signal from the relevant Hall sensor and the relevant calculated setpoint tilt angle.

On the basis of the embodiment described above, an appropriate control device is located in or on the actuator 35, i.e. it is part of the image stabilization device 36. In principle, provision may also be made for an appropriate control device to be an element of the signal processing unit 42, in which case the signals transmitted via the line 50 would change accordingly, for example the signal from the Hall sensors would need to be transmitted to the signal processing unit 42.

In principle, provision may be made for the long-range optical device 10 to be subjected to calibration in an assembly step, said calibration involving the real image deflection being associated with every tilt of the inversion system 17 that is nominally set by means of the control loop and being stored in the long-range optical device 10. This calibration allows an increase in the accuracy of the image stabilization, since mechanical tolerances are compensated for. If the long-range optical device 10 is a binocular long-range optical device, the long-range optical device 10 can be aligned in binocular fashion here. In the case of a binocular long-range optical device in which either a signal processing unit 42 is provided for both the first tube 11 and the second tube 12 or both the first tube 11 and the second tube 12 each have a signal processing unit 42, which are able to communicate with one another, however, it is furthermore possible for parallax compensation to take place. If the range of an observed object is known, for example from the position of a focusing device on the long-range optical device 10, it is possible to calculate the parallaxes and to compensate for them by virtue of an appropriate position of the inversion systems 17, 17′ relative to one another.

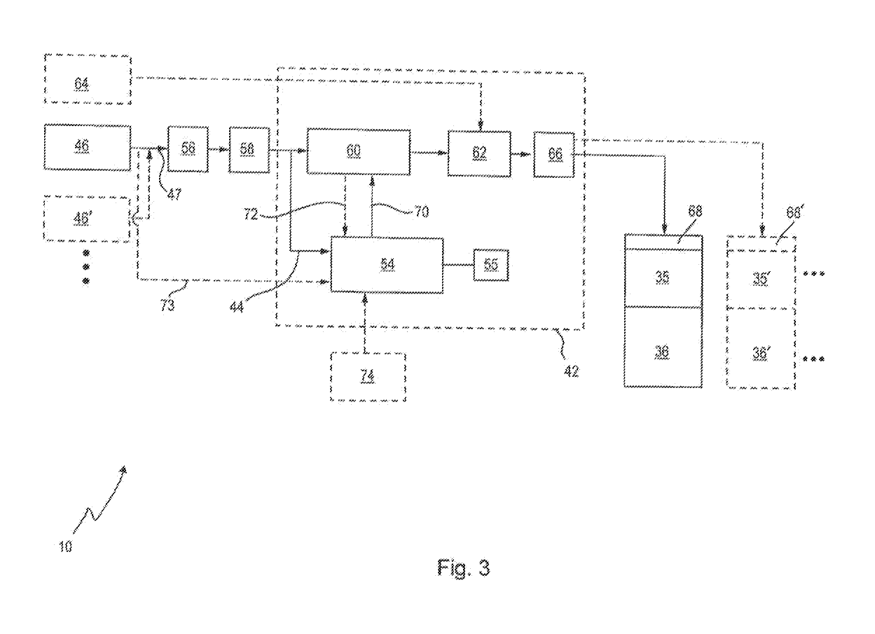

FIG. 3 once again shows an exemplary design for the signal trends in the long-range optical device 10 using a block diagram. At least one sensor element 46 ascertains a measurement signal 47. In principle, there may be more than one sensor element 46 provided, with the result that further sensor elements 46′ deliver further measurement signals 47′.

The measurement signals 47 are converted into the input signals 44, which will be described below, and are then fed into a mode detection unit 54. In this case, the mode detection unit 54 is used to distinguish between different modes for actuation and to stipulate a mode for actuation. A memory unit 55 may store reference profiles, the use of which will be explained below. The mode detection unit 54 can read the reference profiles from the memory unit 55.

For the purpose of filtering the measurement signal 44, signal filters 56 may be provided. The signal filters 56 may contain one or more low-pass filters in order to eliminate high-frequency movements which do not need to be compensated for and the high-frequency component of noise in the measurement signal 47. To this end, it is possible to use a combination of an electric or passive low-pass filter, a digital low-pass filter and a digital shelving filter in series. The respective filter types are known in principle to a person of average skill in the art. In this combination, a signal delay of just 45° occurs. A relatively short delay in the measurement signal 47 is necessary in order to allow image stabilization in real time. In this case, the low-pass filters of the signal filters 56 perform the task of minimizing undesirable noise and interference and of determining an upper cut-off frequency for the image stabilization. The signal filters 56 described and an analogue-to-digital converter 58 are then used to feed the input signals 44 to the signal processing unit 42, particularly the mode detection unit 54 and a high-pass filter integrator unit 60.

The mode detection unit 54 can affect the high-pass filter integrator unit 60 so as to influence the actuation in each mode. As a minimum, the mode detection unit 54 outputs the present mode to the high-pass filter integrator unit 60.

In the embodiment explained by way of example, the input signals 44 are angular speeds, with the result that the integrated signal is an angle. The latter is forwarded from the integrator unit 44 to a coordinate transformation unit 62, which converts the angle from the coordinate system of the sensor elements 46, 46′ into the coordinate system of the image stabilization device 36, 36′. In the case of a binocular long-range optical device 10, in which the first tube 11 and the second tube 12 are connected by means of a folding bridge, there is furthermore a folding bridge sensor 64 provided which ascertains a folding bridge angle and transmits it to the coordinate transformation unit 62 provided in the signal processing unit 42, with the result that the folding bridge angle is also taken into consideration for the coordinate transformation. In principle, the coordinate transformation unit 62 may also be arranged in the signal flow upstream of the integrator unit 44.

Furthermore, a setpoint signal generation unit 66 is schematically shown, and this is able to convert the integrated setpoint angle signals back into analogue signals, in particular, and then outputs the appropriate setpoint angle signal to an appropriate image stabilization device 36, 36′. To this end, the signal processing unit 42 communicates with an appropriate control device 68, 68′ of the image stabilization device 36, 36′, which controls the relevant actuators 35, 35′. Provision may also be made for the control devices 68, 68′ likewise to be provided in the signal processing unit 42, and in this case appropriate position data which are ascertained via Hall sensors, as explained above, flow back to the signal processing unit 42 from the image stabilization devices 36, 36′.

The mode detection unit 54 is connected to the high-pass filter integrator unit 60 and can communicate with it. In this case, a signal line 70 is used to forward particularly the mode determined by the mode detection unit 54 to the high-pass filter integrator unit 60 in order to allow the image stabilization devices 36, 36′ to be actuated in a particular mode. The type of data transmitted by means of the signal line 70 may be embodied differently. By way of example, it is possible for just the mode to be transmitted, but provision may also be made for already determined influencable variables or parameters provided in the high-pass filter integrator 60 to be transmitted. Furthermore, provision may be made for the high-pass filter integrator unit 60 also to be able to transmit signals to the mode detection unit 54 by means of a signal line 72. This may be the mode which is being used at present in the high-pass filter integrator unit 60, for example. In addition, if the measurement signal 47 or the input signal 44 is an acceleration or angular acceleration, for example, then it is possible to transmit to the mode detection unit 54 a signal that has been integrated once to form a speed or angular speed. Thus, even if the measurement signal 47 or the input signal 44 is an acceleration or angular acceleration, it is possible to determine the mode or a movement situation by using a speed signal or angular speed signal.

In principle, provision is made for the movement situation and hence the mode to be determined by using the input signal 44 which has already passed through the signal filter 56 and the analogue-to-digital converter 58. In one refinement, however, provision may also be made for a signal line 73 to be used to use the unfiltered measurement signal 47. The signal line 73 may also contain an analogue-to-digital converter (not shown) in order to convert the signal as appropriate.

Furthermore, an interface device 74 may be provided. By way of example, the interface device 74 may be a mechanical control lever or a mechanical control element, but a software-based input option, for example using a touch screen, may also be provided. A user can use the interface device 74 to input a desired instance of application into the signal processing unit 42. Various instances of application and their significance for determining a mode for actuation will be discussed later.

In one embodiment, provision may be made for input by means of the interface device 74 to take priority over an instance of application that is ascertained by means of the mode detection unit 54.

In particular, the mode detection unit 54 is capable of distinguishing between an image stabilization mode and a swivel mode. This is accomplished by using an evaluation of the input signal 44. As an alternative, it would also be conceivable for the measurement signal 47 to be input into the mode detection unit 54 directly via a line 73 and for the evaluation to be performed using the measurement signal 47. In particular, probability-based determination of the swivel mode is effected as will be described below. A swivel mode can be determined for the vertical axis and for the lateral axis independently, i.e. independently for each measurement signal 47, 47′ from which the input signal 44 is composed. The schematic illustration shows the measurement signals 47, 47′ of serial type on a bus, and parallel processing is also possible, in principle. The way in which the mode detection unit 54 works will now be discussed in more detail below.

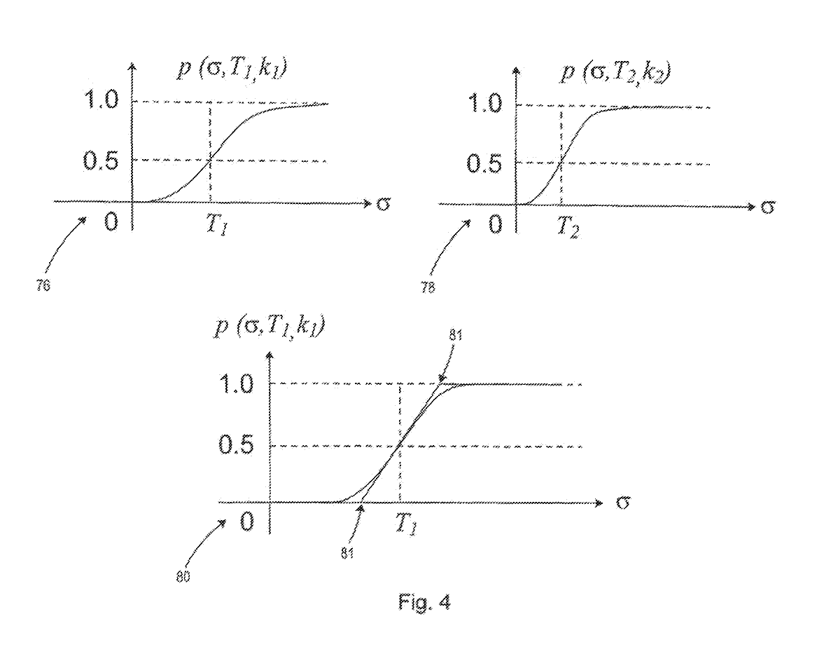

FIG. 4 shows several examples of the trends of the probability function p(σ,T,k) on the basis of an integrated input signal σ and for particular parameters T and k. A first graph 76 plots the trend of p over σ for two particular parameters T₁ and k₁. In this case, the trend is calculated according to the formula

$$p ( σ , T , k ) = \frac{1}{1 + {e}^{- k ( σ - T )}} .$$

On the basis of the formula, a value range between 0 and 1 is obtained. In this case, the parameter T₁ determines the threshold for the function, i.e. that value for σ of which the value is 0.5 or the probability is 50%. The parameter k₁ determines the gradient of the function at the point T₁.

For comparison, a graph 78 plots the trend of the function p for two other parameters T₂ and k₂. In this case, T₂<T₁ and k₂>k₁ apply. Accordingly, it can be seen that the threshold is already reached for a relatively low value of σ and that the gradient at this point is greater. Accordingly, a relatively high probability close to 1.0 is already reached for a relatively low value of σ too.

A graph 80 specifies the trend of the probability for a function that has been linearized by using the formula

$$p ( σ , T , k ) = \{ \begin{matrix} 0 for σ < T - k \\ \frac{σ - ( T - k )}{2 \cdot k} for T - k \leq σ \leq T + k \\ 1 for σ > T + k ,\end{matrix}$$

In the case of the linearized function too, the parameter T indicates the threshold for the function p and the parameter k indicates the gradient of the function p at the point T. On account of the linearization, the function has discontinuities 81, however. Furthermore, the linearized function assumes the precise value 0 for a range less than T−k and the value 1 for a range greater than T+k. The function linearized in this manner differs only marginally from the trend or profile of the exact function, however. The differences are very small particularly for larger values for the parameter k.

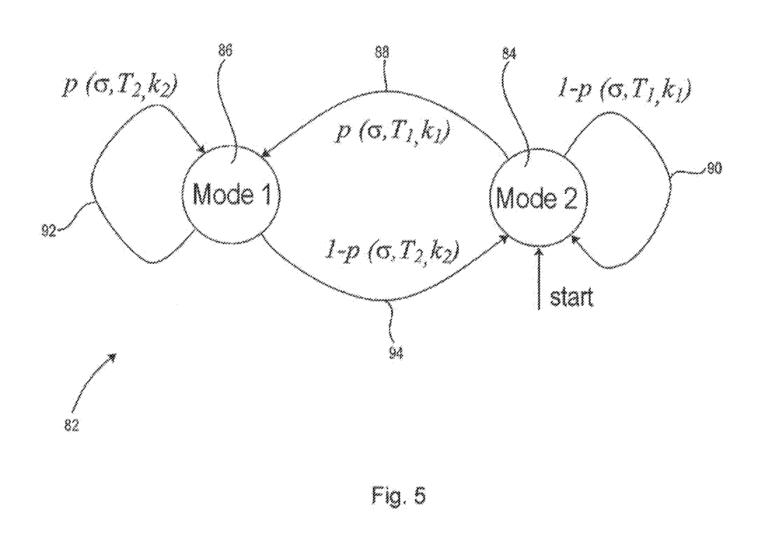

FIG. 5 shows a flow diagram 82 which presents the trend of the decisions using an exemplary embodiment having two different modes. At the beginning of the image stabilization, the initial condition stipulated is that the image stabilization takes place in a second mode 84 which has the associated movement situation “unintentional movement” or “quivering rotary movement”. For the sake of simplicity, it is assumed that no further distinction between different instances of application is made, or that the same instance of application applies during the entire period of time, using this exemplary embodiment. Therefore, if the image stabilization is in the second mode 84 after the start, the parameters T₁ and k₁ apply for determining a probability of a first mode 86 being present. The input signals 44 are integrated over a particular period of time, and thus σ is determined. This thus results in the probability p(σ,T₁,k₁) of changing to the first mode 86, denoted by the reference symbol 88. This accordingly results in a probability 1−p(σ,T₁,k₁) of remaining in the second mode 84, denoted by the reference symbol 90.

If the system is prompted to change 88 to the first mode 86, since a comparison between a random number and the ascertained probability p(σ,T₁,k₁) has resulted in a true statement and hence has prompted the change 88, then the parameters T₂ and k₂ now apply in the first mode 86. The trend of the probability function p(σ,T₂,k₂) is now another, for example as shown in FIG. 4.

The probability is now ascertained on the basis of the formula p(σ,T₂,k₂) and is compared with the random number. Accordingly, a true statement for the presence of the first mode 86 then prompts the system to remain in the first mode 86, which is denoted by a reference symbol 92. Accordingly, a probability 1−p(σ,T₂,k₂) then applies for a change back to the second mode 84, which is denoted by a reference symbol 94.

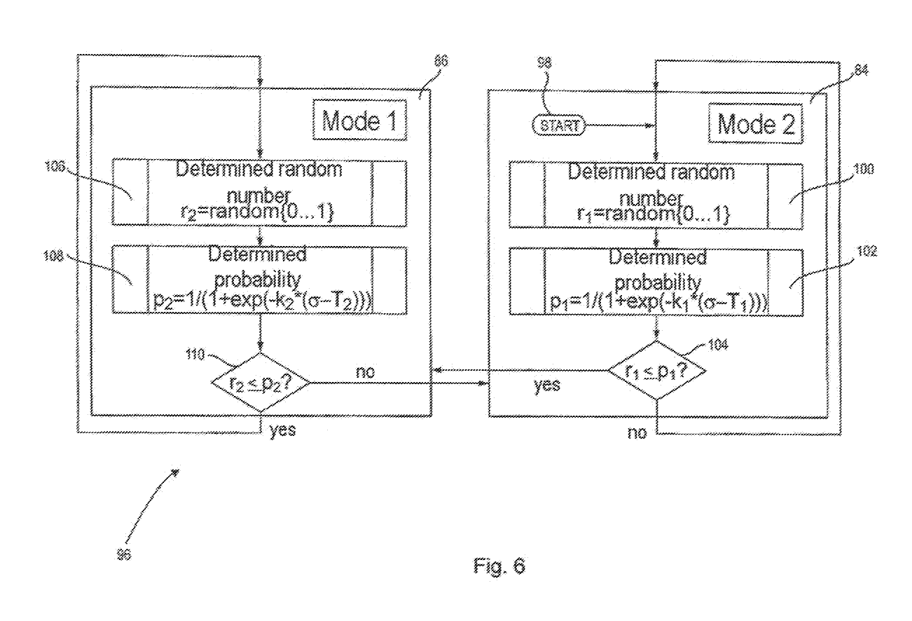

FIG. 6 shows a schematic flowchart for an embodiment of a method 96. The method begins in a starting step 98, and hence it is prescribed that the second mode 84 is present when the method 96 begins. First of all, a random number r₁ is then determined in a step 100. In this case, an appropriate algorithm may be provided which generates an appropriate pseudorandom number in a range from 0 to 1, but it is also possible to generate a genuine random number in a range from 0 to 1, for example from a noise in a sensor signal 47 from a sensor element 46 of the long-range optical device 10.

In a step 102, the probability p₁ of the first mode 86 being present is then ascertained, as described above. In principle, steps 100 and 102 do not need to be executed in the order shown, and can also be effected in reverse order.

A step 104 then ascertains whether the random number r₁ is less than or equal to the probability p₁, and in this way a binary decision is made about the movement situation associated with the mode 86 being present. If this is not the case, the signal processing device 42 remains in the second mode 84 for actuating the image stabilization device 36, 36′. If this is the case, the signal processing device 42 changes to the first mode 86 for actuating the image stabilization device 36, 36′.

In the first mode 86, other parameters k₂ and T₂ then apply. In the first mode 86, a random number r₂ is accordingly likewise determined in a step 106. Next, the probability p₂ is determined with the parameters k₂ and T₂ in a step 108. In this case too, steps 106 and 108 may also take place in reverse order in principle. In a step 110, a test is then performed to determine whether the random number r₂ is less than or equal to the probability p₂. If this is the case, the signal processing device 42 remains in the first mode 86. If this is not the case, the signal processing device 42 changes back to the second mode 84, since the movement situation associated with the first mode 86 is no longer present, but instead the movement situation associated with the second mode 84 is present.

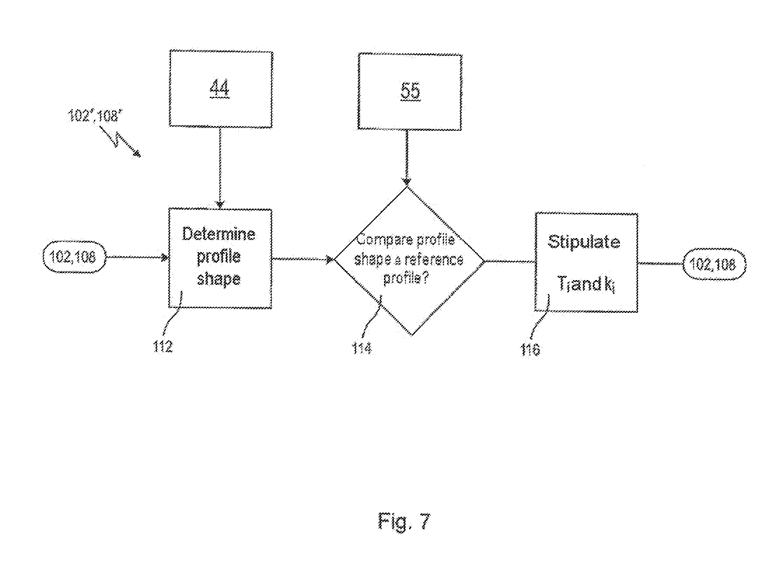

FIG. 7 shows an embodiment of the method in FIG. 6 in which the step of determining the probabilities p₁ 102′ and p₂ 108′ has been modified. In this case, the parameters T₁, k₁ and T₂, k₂ are additionally dependent on a respective instance of application and vary from instance of application to instance of application. In order to ascertain this instance of application, the input signal 44 is first of all used to determine the profile trend thereof in a step 112 within the respective step 102′, 108′. In particular, the profile trend can be determined by analysing the movement patterns in the form of a spectrum or frequency spectrum. In a step 114, this profile trend is then compared with at least one reference profile or reference spectrum which is stored in a memory unit 55 in the signal processing unit 42. By way of example, it is possible in this case to determine a value for the squares of the errors between the profile trend and a respective reference profile and then to identify a respective reference profile as matching the profile trend if the sum of the squares of the errors is below a particular limit value. It is also always possible to associate the reference profile which results in the smallest sum of the squares of the errors in comparison with the profile trend as matching.

The known reference profile is associated with a respective instance of application for which the parameters T₁ and k₁ or T₂ and k₂ or, in the case of yet more modes, also further parameters Tᵢ and kᵢ are then stored. In a step 116, these parameters are then accordingly read and stipulated for the instance of application which is present, and steps 102′ and 108′ are continued by determining the probability p₁ or p₂.

Furthermore, provision may be made for a user of the long-range optical device 10 to prescribe the instance of application by means of the interface device 74. In particular, this manual prescribing of the instance of application by the user may take priority over the automatic identification shown in FIG. 7. The prescribing of the instance of application by means of the interface device 74 then takes priority over the automatic ascertainment by the mode detection unit 54.

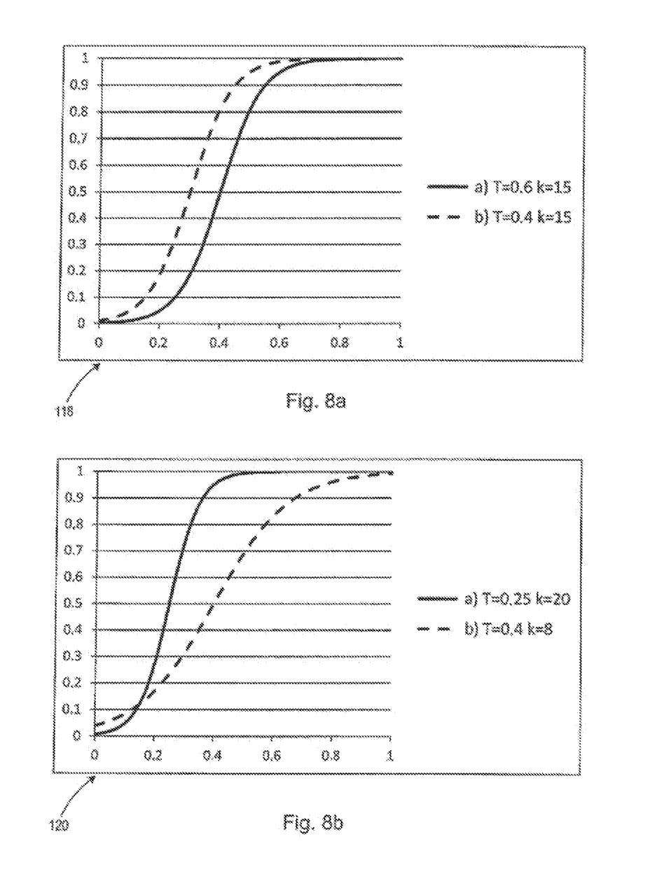

FIG. 8a shows a graph 118 with an example of an illustration of a trend of a probability for different parameters T and k stipulated on the basis of mode. The input signal is scaled to a range from 0 to 1 on a horizontal axis, and the vertical axis is used to plot the probability. The values indicated under a) for the parameters T and k may apply in the second mode 84, for example, in this case. The values indicated under b) for the parameters T and k may apply in the first mode 86, for example, in this case. The parameter T is then chosen to be smaller in the first mode 86 than in the second mode 84, since when an intentional movement is already present there is usually a greater probability of a further intentional movement. This introduces a hysteresis for a change between the first mode 86 and the second mode 84.

FIG. 8b shows a graph 120 with an example of an illustration of a trend of a probability for different parameters T and k stipulated on the basis of an instance of application. The input signal is scaled to a range from 0 to 1 on the horizontal axis, and the vertical axis is used to plot the probability. The indicated values apply for a change from the second mode 84 to the first mode 86 in this case. For the converse change, the values for the parameter T would need to be chosen to be smaller in accordance with the illustration in FIG. 8a in order to obtain the hysteresis described therein.

By way of example, the values indicated under a) may apply for a “calm foundation” instance of application, e.g. on firm ground. The parameter T has been stipulated to be relatively small for this instance of application, and the parameter k has been stipulated to be relatively large, since a movement that goes beyond normal quivering has a high probability of being an intentional movement. By way of example, the values indicated under b) apply for a “moving foundation” instance of application, e.g. in a moving vehicle. For this instance of application, the parameter T has been stipulated to be in a midrange, and the parameter k has been stipulated to be relatively small, since a transition between an intentional movement and an unintentional movement is fluid in this instance of application. This is depicted by a correspondingly “soft” curve.

The values indicated under a) and b) can also apply for a manually set instance of application or for an automatically ascertained instance of application. By way of example, the values indicated under a) can thus be assigned a manually adjustable or automatically identifiable “calm user type” user profile and the values indicated under b) can be assigned a manually adjustable or automatically identifiable “active user type” user profile.

What is claimed is:

1. A long-range optical device having at least one tube in which an optical system is positioned, having at least one image stabilization device which is designed to move at least one optical assembly of the optical system relative to the at least one tube, having at least one signal processing unit which is designed such that it actuates the at least one image stabilization device in one mode from a plurality of modes, wherein each mode has an associated respective movement situation for the long-range optical device, and having a mode detection unit which is designed such that it determines the mode from the plurality of modes, wherein the mode detection unit is furthermore designed such that it determines the mode by ascertaining a probability of presence of a first movement situation which has an associated first mode, and takes a comparison of the ascertained probability with a random number as a basis for making a decision about actuation in the first mode.

2. The long-range optical device according to claim 1, wherein the mode detection unit is designed such that it makes a decision about actuation in the first mode by making a decision about changing to the first mode when the at least one signal processing unit actuates the at least one image stabilization device in another, second mode, and makes a decision about remaining in the first mod when the at least one signal processing unit is already actuating the at least one image stabilization device in the first mode.

3. The long-range optical device according to claim 1, wherein the mode detection unit is designed such that it ascertains the probability using the formula
$$p ( σ , T , k ) = \frac{1}{1 + {e}^{- k ( σ - T )}} .$$
where p is the probability, k and T are each a parameter greater than zero and σ is the value of an input signal integrated over a particular period of time.

4. The long-range optical device according to claim 1, wherein the mode detection unit is designed such that it ascertains the probability using the formula
$$p ( σ , T , k ) = \{ \begin{matrix} 0 for σ < T - k \\ \frac{σ - ( T - k )}{2 \cdot k} for T - k \leq σ \leq T + k \\ 1 for σ > T + k ,\end{matrix}$$
where p is the probability, k and T are each a parameter greater than zero and σ is the value of an input signal integrated over a particular period of time.

5. The long-range optical device according to claim 1, wherein the mode detection unit is designed such that the probability is dependent on an input signal integrated over a particular period of time, wherein the input signal is a speed or angular speed of the long-range optical device.

6. The long-range optical device according to claim 1, wherein the mode detection unit is designed such that the probability is dependent on an input signal integrated over a particular period of time, wherein the input signal is an acceleration or angular acceleration of the long-range optical device.

7. The long-range optical device according to claim 1, wherein the mode detection unit is designed such that the random number is formed from a noise in a sensor signal from a sensor element of the long-range optical device.

8. The long-range optical device according to claim 3, wherein the mode detection unit is designed such that it stipulates the parameters k and T on the basis of a mode in which the image stabilization device is actuated and/or stipulates them on the basis of an instance of application.

9. The long-range optical device according to claim 8, wherein the long-range optical device has an interface device which is designed to set the instance of application.

10. The long-range optical device according to claim 8, wherein the long-range optical device furthermore has a memory unit which stores at least one reference profile, wherein a respective reference profile has a respective associated instance of application, and the mode detection unit is designed such that it uses a comparison of a trend of the input signal over a particular period of time with the at least one reference profile to stipulate the instance of application.

11. The long-range optical device according to claim 10, wherein the mode detection unit is designed such that it stipulates the incidence of application continuously or at regular intervals of time.

12. The long-range optical device according to claim 4, wherein the mode detection unit is designed such that it stipulates the parameters k and T on the basis of a mode in which the image stabilization device is actuated and/or stipulates them on the basis of an instance of application.

13. The long-range optical device according to claim 12, wherein the long-range optical device has an interface device which is designed to set the instance of application.

14. The long-range optical device according to claim 12, wherein the long-range optical device furthermore has a memory unit which stores at least one reference profile, wherein a respective reference profile has a respective associated instance of application, and the mode detection unit is designed such that it uses a comparison of a trend of the input signal over a particular period of time with the at least one reference profile to stipulate the instance of application.

15. The long-range optical device according to claim 14, wherein the mode detection unit is designed such that it stipulates the incidence of application continuously or at regular intervals of time.

16. A method for determining a mode for actuation of an image stabilization device in a long-range optical device, wherein the image stabilization device is actuated in one mode from a plurality of modes, wherein each mode has an associated respective movement situation for the long-range optical device, wherein the mode from the plurality of modes is ascertained by determining a probability of presence of a first movement situation which has an associated first mode and using a comparison of the ascertained probability with a random number to make a decision about actuation in the first mode.

17. The method according to claim 16, wherein the decision about the actuation in the first mode is made by making a decision about changing to the first mode when the at least one image stabilization device is being actuated in another, second mode, and a decision about remaining in the first mode is made when the at least one image stabilization device is already being actuated in the first mode.

18. A computer program having program code means which is designed to execute all the steps of a method for determining a mode for actuation of an image stabilization device in a long-range optical device, wherein the image stabilization device is actuated in one mode from a plurality of modes, wherein each mode has an associated respective movement situation for the long-range optical device, wherein the mode from the plurality of modes is ascertained by determining a probability of presence of a first movement situation which has an associated first mode and using a comparison of the ascertained probability with a random number to make a decision about actuation in the first mode, when the computer program is executed on a computer.

19. A computer program product having program code means which are stored on a computer-readable data storage medium in order to perform a method for determining a mode for actuation of an image stabilization device in a long-range optical device, wherein the image stabilization device is actuated in one mode from a plurality of modes, wherein each mode has an associated respective movement situation for the long-range optical device, wherein the mode from the plurality of modes is ascertained by determining a probability of presence of a first movement situation which has an associated first mode and using a comparison of the ascertained probability with a random number to make a decision about actuation in the first mode, when the computer program is executed on a computer or an appropriate data processing unit.
